(19) United States
(12) Patent Application Publication
(10) Pub. No.: US 2026/0150065 A1
(43) Pub. Date: May 28, 2026

(54) SYSTEMS AND METHODS FOR IMPROVED LOCATION ESTIMATION USING RESIDUAL TIMING ADVANCE CORRECTION

(71) Applicant: Verizon Patent and Licensing Inc., Basking Ridge, NJ (US)

(72) Inventors: Asif Dawoodi Gandhi, Edison, NJ (US); Chin Chiu, Allen, TX (US); Kevin Donnellan, North Brunswick, NJ (US); Jack Anthony Smith, Burkburnett, TX (US)

(21) Appl. No.: 18/956,165

(22) Filed: Nov. 22, 2024

(51) Int. Cl. H04W 56/00; H04W 28/20; H04W 64/00

(52) U.S. Cl. CPC H04W 56/0045; H04W 28/20; H04W 64/003

(57) ABSTRACT

Systems and methods described herein provide an improved location estimation service using timing advance corrections. A network device in a Radio Access Network (RAN) receives a request for location information. In response the network device obtains location measurements for a User Equipment (UE) device. The location measurements include a timing advance delta for a received uplink radio frame. The network device sends a response to the request that includes the timing advance delta.

### BACKGROUND

Cellular networks (e.g., Fifth Generation (5G) networks) provide various services and applications to user devices connected via a radio access network (RAN). UE location determination is important for multiple use cases (such as enhanced 911 services and location based services) for 5G System (5GS) and beyond. Multiple stakeholders are interested in obtaining location information and monetizing the information. Given the monetizing potential of location services, there can be reluctance to share information amongst the multiple stakeholders (i.e., beyond what may be mandated by law enforcement, regulations, etc.).

A location management function (LMF) is a positioning related network function (NF) introduced in the 5GS. The 5GS may support location determination for a UE device using the LMF. The LMF can be included in the 5GS as part of either a core network or as part of a 5G RAN, depending on different use cases.

### BRIEF DESCRIPTION OF THE DRAWINGS

FIG. 1 is a diagram that depicts an example network environment in which systems and methods described herein may be implemented;

FIG. 2 is a diagram illustrating network portions for location estimation service using timing advance (TA) corrections, according to implementations described herein;

FIG. 3 is a diagram of example components of a device according to an implementation described herein;

FIG. 4A-4C are diagrams illustrating a TA delta that may be observed by a wireless access station in the context of a cyclic prefix;

FIG. 5 is a table providing values of time and distance relating to concepts described in connection with FIGS. 4A-4C;

FIG. 6 is a signal flow diagram illustrating communications to provide a TA correction value to a location management function (LMF);

FIG. 7 is a flow diagram illustrating an exemplary process for providing optimized paging using UE trajectory prediction, according to an implementation; and

FIG. 8 is a diagram illustrating a use case for providing an improved location estimation service using TA corrections.

### DETAILED DESCRIPTION

The following detailed description refers to the accompanying drawings. The same reference numbers in different drawings may identify the same or similar elements. Also, the following detailed description does not limit the invention.

Systems and methods described herein provide an improved location estimation service using timing advance (TA) corrections for individual user equipment (UE) devices. The TA corrections are based on measured frame start timing. The TA corrections may be identified and calculated by 5G Next Generation (NG) RAN devices (e.g., a next generation Node B (gNB) or a combined gNB/evolved Node B (eNB)). According to implementations described herein, the high-resolution capability of the RAN devices to determine the frame start timing may be used to calculate a UE-specific delta which can complement the UE-specific TA and provide an improved estimate of distance. In one implementation, the RAN devices may provide TA corrections to a location management function (LMF), for example, as part of a response to a UE location estimate request. Such an additional measurement, referred to herein as a TA delta, can contribute to enhanced UE location information accuracy.

Some vertical use cases require accurate positioning information to be provided quickly, above a positioning determination latency threshold. For such use cases, it may be necessary to have the LMF be part of the RAN. For other use cases that do have positioning latency requirements, the LMF can be part of the core network to provide centralized location-assistance services. In some cases, combinations of core-based and RAN-based LMFs may be used.

According to an exemplary embodiment, a RAN device may receive a request for location information. In response, the network device may obtain location measurements for a UE device. The location measurements may include a timing advance delta for a received uplink radio frame. The network device may send a response to the request that includes the timing advance delta.

According to one implementation, the request for location information may originate from an LMF in a core network and be forwarded to the RAN device via an access and mobility management function (AMF). In another implementation, the request for location information may include a UE identifier for the UE device and a routing identifier for the LMF that originated the request.

According to another implementation, the timing advance delta may be computed based on a signal sent over a Physical Uplink Control Channel (PUCCH), a Physical Uplink Shared Channel (PUSCH), or a Sounding Reference Signal (SRS). The timing advance delta may include a sampling rate for a carrier bandwidth used by the UE device and an integer value corresponding to a number of sampling intervals. The sampling rate and integer value may be used to calculate a distance (e.g., an additional distance of the UE from the base station relative to the timing advance).

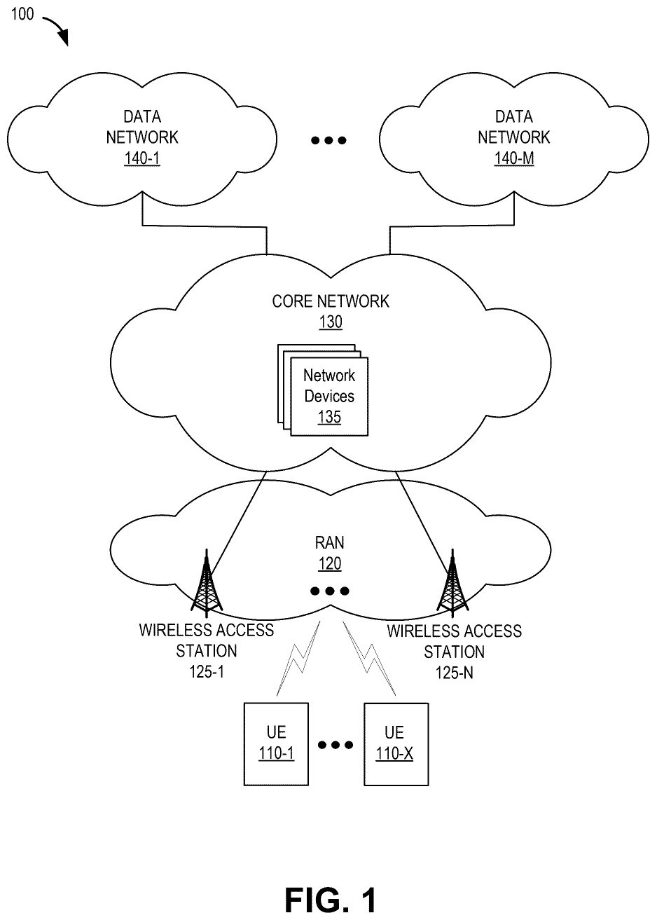

FIG. 1 is a diagram of an example environment 100 in which systems and/or methods, described herein, may be implemented. As shown in FIG. 1, environment 100 may include UE devices 110-1 to 110-X (referred to herein collectively as “UE devices 110” and individually as “UE device 110”), a RAN 120, a core network 130, and one or more data networks 140 (referred to herein collectively or generically as “data network 140”).

UE device 110 may include any device with long-range (e.g., cellular or mobile wireless network) wireless communication functionality. For example, UE device 110 may include a handheld wireless communication device (e.g., a mobile phone, a smart phone, a tablet device, etc.); a wearable computer device (e.g., a head-mounted display computer device, a head-mounted camera device, a wristwatch computer device, etc.); a telematics system in a vehicle; a portable computer; a desktop computer; a customer premises equipment (CPE) device, such as a set-top box or a digital media player, a fixed wireless access (FWA) device, a smart television, etc.; an automated guided vehicle (AGV); a portable gaming system; an Internet of Things (IoT) device; and/or any other type of computer device with wireless communication capabilities. In some implementations, UE device 110 may communicate using machine-to-machine (M2M) communication, such as machine-type communication (MTC), and/or another type of M2M communication. In still other implementations, UE device 110 may include a Redcap (Reduced capability) device that is used for applications such as industrial wireless sensors.

RAN 120 may enable UE devices 110 to connect to core network 130 for mobile telephone service, Short Message Service (SMS), Multimedia Message Service (MMS), Internet access, cloud computing, and/or other types of data services. RAN 120 may include wireless access stations 125-1 to 125-N (referred to herein collectively or generically as “wireless access station 125”). Each wireless access station 125 may service a set of UE devices 110. For example, wireless access station 125-1 may service some UE devices 110 when the UE devices 110 are located within the geographic area serviced by wireless access station 125-1, while other UE devices 110 may be serviced by another wireless access station 125 when the UE devices 110 are located within the geographic area serviced by the other wireless access station 125.

Wireless access station 125 may include a 5G base station (e.g., a gNB) that includes one or more radio frequency (RF) transceivers configured to send and receive 5G New Radio (NR) wireless signals. According to an implementation, a wireless access station 125 may include a gNB or its equivalent with multiple distributed components, such as a central unit (CU), a distributed unit (DU), a radio unit (RU, or a remote radio unit (RRU)), or another type of component. Wireless access station 125 may include one or more next generation eNBs (ng-eNBs) which provide Long-Term Evolution (LTE) wireless access to UE devices 110 and may connect to network devices 135 in core network 130, such as an AMF, as described further herein. Furthermore, in some implementations, wireless access station 125 may include a Multi-Access Edge Computing (MEC) system that performs cloud computing and/or provides network processing services for UE devices 110. For example, according to some implementations, wireless access station 125 may include one or more LMF instances.

Core network 130 may manage communication sessions for UE devices 110. Core network 130 may provide mobility management, session management, authentication, and packet transport, to support wireless communication services for UE devices 110. Core network 130 may further provide access to data networks 140. Core network 130 may be compatible with known wireless standards which may include, for example, 3GPP 5G (non-standalone (NSA) and standalone (SA)), Long-Term Evolution (LTE), LTE Advanced, Global System for Mobile Communications (GSM), etc. For example, core network 130 may establish an Internet Protocol (IP) connection between UE device 110 and a particular data network 140. Core network 130 may include various types of network devices 135, which may implement different network functions described further herein.

Data networks 140 may each include a packet data network. A particular data network 140 may include, and/or be connected to and enable communication with, a local area network (LAN), a wide area network (WAN), a metropolitan area network (MAN), an optical network, a cable television network, a satellite network, a wireless network, an intranet, or a combination of networks. Some or all of a particular data network 140 may be managed by a communication services provider that also manages core network 130, RAN 120, and/or particular UE devices 110.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

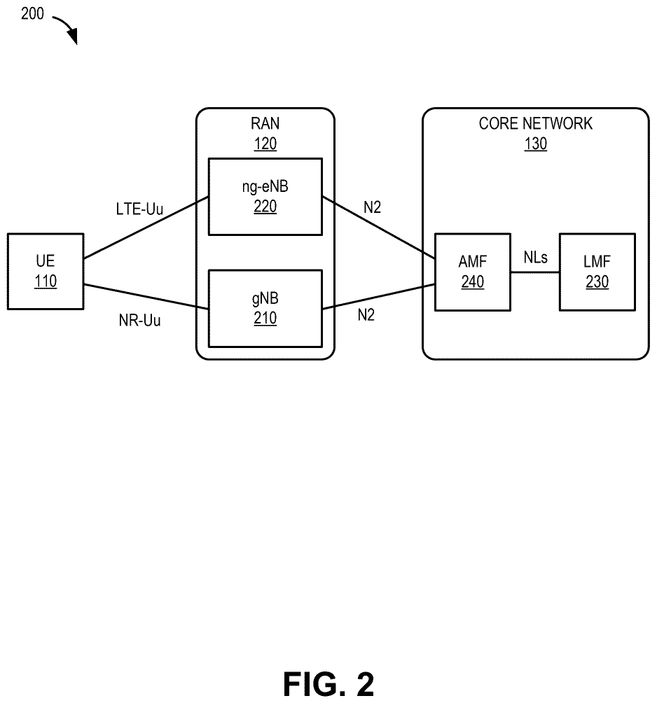

FIG. 2 is a diagram illustrating a network portion 200 that includes exemplary components of environment 100 in the context of the improved location estimation service using TA corrections, according to an implementation described herein. As shown in FIG. 2, network portion 200 may include UE device 110, a gNB 210, an eNB 220, an LMF 230, an AMF 240. While FIG. 2 depicts a single instance of the network functions in network portion 200 for illustration purposes, in practice, there may be multiple instances of one or more network functions.

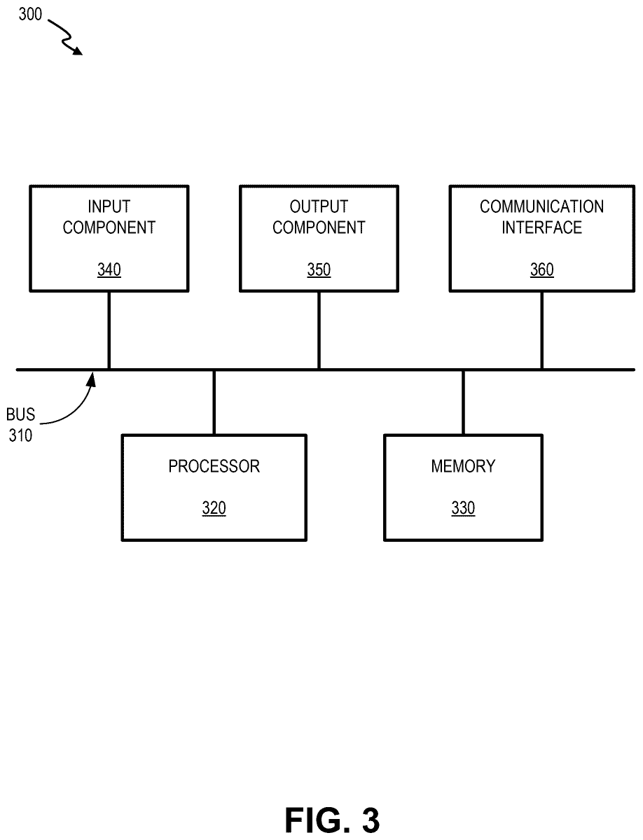

The components depicted in FIG. 2 may be implemented as dedicated hardware components (e.g., network devices 135) or as virtualized functions implemented on top of a common shared physical infrastructure using software defined networking (SDN). For example, an SDN controller may implement one or more of the components of FIG. 2 using an adapter implementing a virtual machine, a containerized network function (CNF) container, an event driven serverless architecture interface, and/or another type of SDN architecture. The common shared physical infrastructure may be implemented using one or more devices 300, described below with reference to FIG. 3, in a cloud computing center associated with core network 130.

Each of gNB 210 and eNB 220 may correspond to a wireless access device 125. A gNB 210 may support wireless communications with UE devices 110 using NR (e.g., 5GS) protocols. An ng-eNB 220 may include, for example, an eNB that provides LTE wireless access to UE devices 110 while supporting a backend interface to 5G network elements. According to implementations described herein, each of gNB 210 and eNB 220 (referred to generically as a wireless access device 125) may be configured to receive (e.g., from LMF 230 via AMF 240) a request for location information. In response, wireless access device 125 may obtain location measurements for a requested UE device 110. The location measurements obtained by wireless access device 125 may include a timing advance delta for a received uplink radio frame. Wireless access device 125 may be configured to provide (e.g., to LMF 230 via AMF 240) a response, to the request, which includes the timing advance delta.

As shown in FIG. 2, components of core network 130 may include an LMF 230 and an AMF 240. LMF 230 supports location determination for a UE device 110 based on positioning methods such as Downlink Time difference of Arrival (DL-TDOA), Uplink Time difference of Arrival (UL-TDOA), Uplink Angle of Arrival (UL-AoA), Multi-round trip time (RTT), DL positioning resources (PRS) for DL Angle of Departure (AoD), global navigation satellite system (GNSS) based methods, etc. LMF 230 may also obtain non-UE associated position assistance data from RAN 120. LMF 230 may use the location/position data to provide broadcast assistance data to UE devices, for example. LMF 230 may also support operations for critical network slices, such as network slices for Ultra-Reliable Low-Latency Communication (URLLC), Time-Sensitive Networking (TSN), Vehicle-to-Everything (V2X) communications, or other network slices that depend on location information. When LMF 230 is located in core network 130, LMF 230 may exchange positioning information and measurements with RAN 120 via the New Radio Positioning Protocol Annex (NRPPa) protocol, for example.

LMF 230 may obtain downlink location measurements or a location estimate from UE device 110, uplink location measurements from RAN 120 (e.g., a wireless access device 125), and/or non-UE associated assistance data from RAN 120. LMF 230 may receive measurements and assistance information from the RAN 120 and the UE device 110, via the AMF 240 over an NLs interface to compute the position of UE device 110. According to implementations described herein, LMF 230 may receive a TA correction distance, or TA delta, from devices in RAN 120 in addition to the other location-related information described above.

AMF 240 may perform registration management, connection management, reachability management, mobility management, lawful intercepts, Short Message Service (SMS) transport, session management message transport between UE device 110 and a Session Management Function (SMF), access authentication and authorization, location services management, functionality to support non-3GPP access networks, and/or other types of management processes. According to implementations described herein, AMF 240 may forward location information requests and location information responses, including a TA correction distance, between RAN 120 and LMF 230.

Although FIG. 2 shows certain components of network portion 200, in other implementations, network portion 200 may include fewer components, different components, differently arranged components, or additional components than depicted in FIG. 2. For example, although not illustrated in FIG. 2, core network 130 may include other network functions (e.g., implemented in network devices 135), such as an SMF, a User Plane Function (UPF), a Unified Data Management (UDM), a Policy Control Function (PCF), a Network Exposure Function (NEF), a network data analytics function (NWDAF), a Charging Enablement Function (CEF), a Network Repository Function (NRF), a Network Slice Selection Function (NSSF), etc. Additionally, or alternatively, one or more components of network portion 200 may perform functions described as being performed by one or more other components of network portion 200. Furthermore, while particular interfaces (e.g., NLs, NG-C, N2, etc.) are illustrated with respect to particular functional nodes in FIG. 2, some network functions may include other interfaces, such as a reference point architecture that includes point-to-point interfaces between particular function nodes.

FIG. 3 illustrates example components of a device 300 according to an implementation described herein. UE device 110, wireless access station 125, network device 135, LMF 230, AMF 240, and other devices in environment 100 may each include one or more devices 300. Device 300 may include a bus 310, a processor 320, a memory 330, an input component 340, an output component 350, and a communication interface 360.

Bus 310 may include a path that permits communication among the components of device 300. Processor 320 may include a processor, a microprocessor, or processing logic that may interpret and execute instructions. Memory 330 may include any type of dynamic storage device that stores information and instructions, for execution by processor 320, and/or any type of non-volatile storage device that stores information for use by processor 320. Input component 340 may include a mechanism that permits a user to input information to device 300, such as a keyboard, a keypad, a button, a switch, etc. Output component 350 may include a mechanism that outputs information to the user, such as a display, a speaker, one or more light emitting diodes (LEDs), etc.

Communication interface 360 may include a transceiver that enables device 300 to communicate with other devices and/or systems via wireless communications, wired communications, or a combination of wireless and wired communications. For example, communication interface 360 may include mechanisms for communicating with another device or system via a network. Communication interface 360 may include an antenna assembly for transmission and/or reception of RF signals. For example, communication interface 360 may include one or more antennas to transmit and/or receive RF signals over the air. In one implementation, for example, communication interface 360 may communicate with a network and/or devices connected to a network. Alternatively, or additionally, communication interface 360 may be a logical component that includes input and output ports, input and output systems, and/or other input and output components that facilitate the transmission of data to other devices.

Device 300 may perform certain operations in response to processor 320 executing software instructions contained in a computer-readable medium, such as memory 330. A computer-readable medium may be defined as a non-transitory memory device. A memory device may include a single physical memory device or multiple physical memory devices. The software instructions may be read into memory 330 from another computer-readable medium or from another device. When executed by processor 320, the software instructions contained in memory 330 may cause processor 320 to perform processes described herein. Alternatively, hardwired circuitry may be used in place of or in combination with software instructions to implement processes described herein. Thus, implementations described herein are not limited to any specific combination of hardware circuitry and software.

Although FIG. 3 shows exemplary components of device 300, in other implementations, device 300 may contain fewer components, additional components, different components, or differently arranged components than those depicted in FIG. 3. Additionally, or alternatively, one or more components of device 300 may perform one or more tasks described as being performed by one or more other components of device 300.

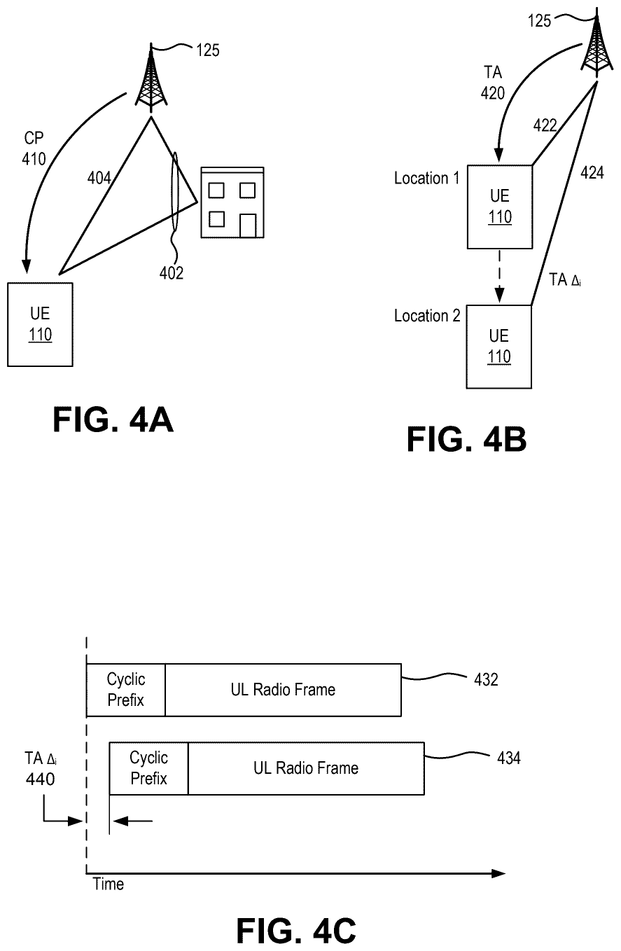

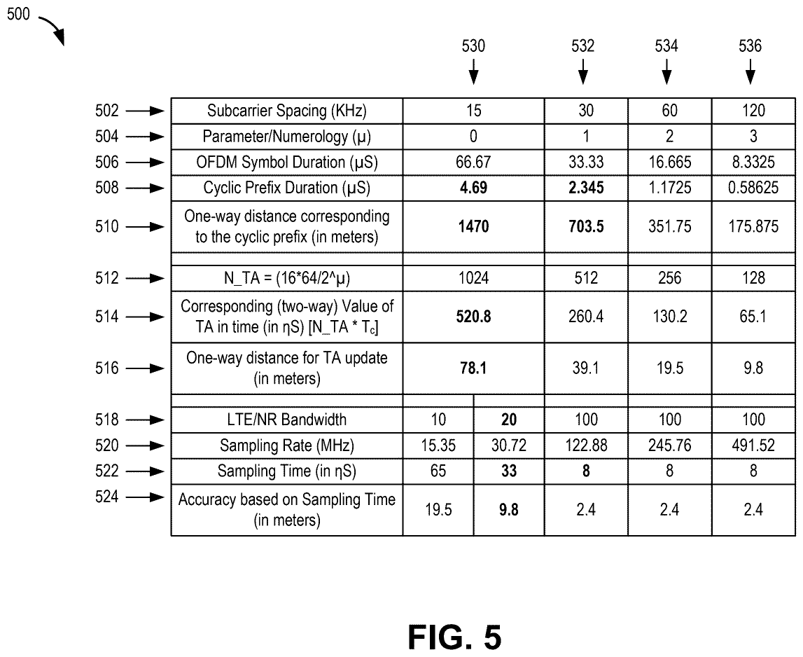

FIGS. 4A-4C illustrates a TA delta that may be observed by wireless access device 125 in the context of a cyclic prefix. FIG. 5 is a table 500 providing estimated values of time and distance relating to concepts described in connection with FIGS. 4A-4C. Table 500 includes a set of parameter fields 502-524 with a variety of entries 530-536.

As illustrated in FIG. 4A, a cyclic prefix (CP) 410 can be assigned based on the Subcarrier Spacing (SCS) and other parameters of the OFDM system for communications between a UE device 110 and wireless access device 125 to compensate for possible signal delays due to, for example, a multipath channel 402 versus a direct path 404. Wireless access device 125 may assign the cyclic prefix value for use by UE device 110 in uplink communications to wireless access device 125, for example. The duration of the cyclic prefix is such that it is typically longer than the maximum delay spread caused by the multipath channel 404. The CP duration may also correspond to a one-way distance of signal travel, which may vary with the sub-carrier spacing (SCS) frequency. As shown in FIG. 5, for example, a sub-carrier spacing (SCS) of 15 KHz uses a cyclic prefix of 4690 nanoseconds (ηs) (or 4.69 microseconds (μs), as illustrated in table 500 (i.e., parameter 508 of entry 530)) which corresponds to 1407 meters of excess distance that can be compensated (i.e., parameter 510 of entry 530). As another example illustrated in FIG. 5, an SCS of 30 KHz uses a cyclic prefix of 2345 ηs (or 2.345 μs, as illustrated in table 500 (i.e., parameter 508 of entry 532)), which corresponds to 703.5 meters of excess distance that can be compensated (i.e., parameter 510 of entry 532).

As illustrated in FIG. 4B, a timing advance (TA) value 420 may also be assigned to UE device 110. The timing advance may be calculated to compensate for uplink signal transmission times at different distances between UE device 110 and wireless access device 125. Timing advance provides a rough compensation for the distance of UE device 110 from wireless access device 125 to facilitate decoding uplink signals. As shown in table 500 of FIG. 5, for example, a SCS of 15 KHz (i.e., parameter 502 of entry 530) typically uses a step size of 78.1 meters (i.e., parameter 516 of entry 530), which corresponds to 520.8 ηs of two-way propagation time (i.e., parameter 514 of entry 530) based on a 5G NR Chip Time interval (T_{c}) of 0.508626 ηs). For the purpose of calculating the distance from the UE device 110 to the wireless access device 125, the one-way distance corresponds to 260.4 ηs.

A timing advance value may be provided to UE device 110 during a random access procedure, for example, and updated periodically. Since the timing advance value is provided in an over-the-air message, the frequency of timing advance adjustments may be limited to conserve resources. Thus, the accuracy of an assigned TA value, relative to the changing location of a UE device 110, may decrease between periodic updates. For example, UE device 110 may be assigned a TA value 420 based on signal data at “Location 1” of FIG. 4B. UE device 110 may continue to use TA value 420 for uplink signals while at “Location 2.” Uplink signals 422 sent from “Location 1” using TA value 420 may arrive at wireless access device 125 with expected timing. Uplink signals 424 sent from “Location 2” using TA value 420 may arrive at a slightly later time, creating a timing advance delta (TA Δᵢ).

FIG. 4C is an illustration comparing timing of a baseline or expected UL radio frame 432 and a received UL radio frame 434 (e.g., sent from Location 2 of FIG. 4B). An expected arrival time for uplink signals is known to wireless access device 125 based on the assigned timing advance for UE device 110. Referring to FIG. 4C, the cyclic prefix 410 assigned for UE device 110 is sufficient to compensate for the timing advance delta to enable wireless access device 125 to decode incoming frames. That is, as long as the cyclic prefix associated with UL radio frame 432 overlaps the cyclic prefix associated with UL radio frame 434, wireless access device 125 can align/decode the signals. Even though wireless access device 125 can decode the signals in radio frame 434 without accounting for the TA Δᵢ 440, TA Δᵢ 440 may be observed/detected by wireless access device 125. The TA Δᵢ may be evaluated as the residual time difference between the baseline frame 432 start time and the UE frame 434 start time after the TA correction has been applied.

Correcting for TA delta 440 is not necessary for the uplink signal to be decoded, but, according to implementations described herein, this value can be used to provide a more accurate estimate of the distance of UE device 110 from wireless access device 125. In addition to the ability to apply the above numbers for cyclic prefix or timing advance, wireless access device 125 has ability to observe the timing much more accurately. As shown in FIG. 5, for 20 MHz Bandwidth (i.e., parameter 518 of entry 532), wireless access device 125 can get the start of a received UL frame accurate up to 33 ηs (the sampling time, as indicated at parameter 522 of entry 530), which may correspond to 9.8 meters (i.e., parameter 524 of entry 530). As also shown in FIG. 5, for 100 MHz Bandwidth (i.e., parameter 518 of entry 532) a gNB can get the frame boundary accurate to as much as 8 ηs (i.e., parameter 522 of entry 532), which may correspond to 2.4 meters (i.e., parameter 524 of entry 532). Wireless access device 125 may compute TA delta 440 and send that value back to LMF 230, for example, as part of a response to a UE Location estimate request.

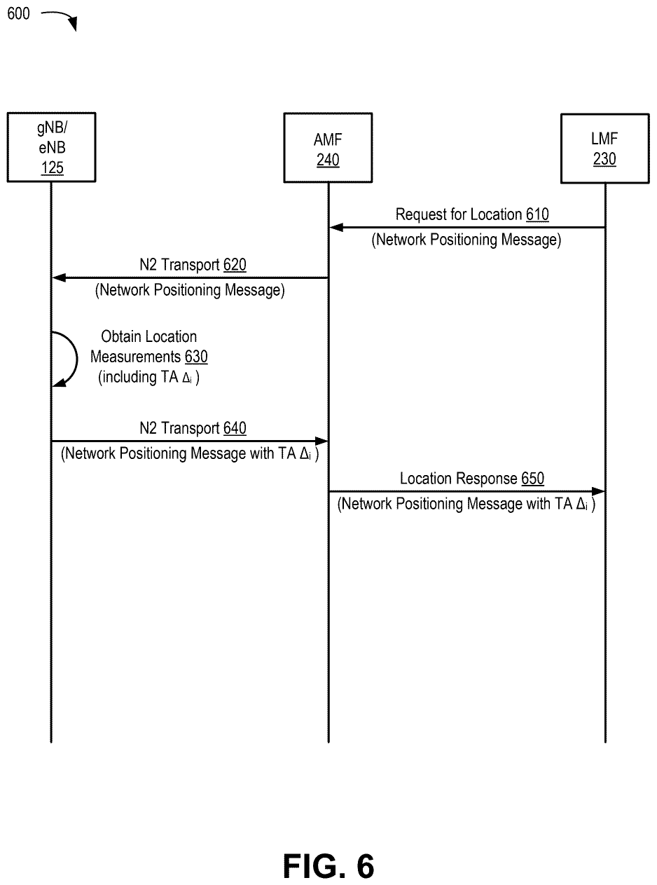

FIG. 6 is a signal flow diagram illustrating communications in a portion 600 of network environment 100 to support improved location estimation service using timing advance (TA) corrections. As shown in FIG. 6, network portion 600 may include wireless access device 125, LMF 230, and AMF 240. Communications shown in FIG. 6 provide simplified illustrations of communications in network portion 600 and are not intended to reflect every signal or communication exchanged between devices/functions.

As shown in FIG. 6, LMF 230 may send a transport message 610 (e.g. a location request) to AMF 240 requesting that a network positioning message (e.g. an NRPPa message) be sent to the serving wireless access station 125 for UE device 110 within the RAN 120. Transport message 610 may include the network positioning message and a UE identifier for UE device 110 (e.g., a unique alphanumeric string, such as a Mobile Station International Subscriber Directory Number (MSISDN), an International Mobile Equipment Identity (IMEI), an International Mobile Subscriber Identity (IMSI), etc.). The network positioning message may request location information for UE device 110 from the RAN 120 (e.g. from a serving gNB 210 or serving ng-eNB 220 for UE device 110).

AMF 240 may receive transport message 610 and forward the network positioning message (e.g., an NRPPa message) to the RAN 120 (e.g., to the serving gNB 210 or serving ng-eNB 220 for UE device 110) in a transport message 620 (e.g. an N2 Transport message). AMF 240 may include a routing identifier in the transport message, identifying LMF 230 (e.g. a global or local address of LMF 230). If UE device 110 is in an idle state, AMF 240 may first initiate a network triggered service request procedure to establish a signaling connection with the UE device 110. Thus, AMF 240 may page UE device 110 to establish a signaling connection to the UE device 110 prior to forwarding any NRPPa message to the RAN 120.

RAN 120 (e.g., gNB 210 or ng-eNB 220) may receive transport message 620. In response, as indicated at reference 630, RAN 120 may obtain location-related information for the UE device 110 that is the subject of message 610. The location-related information may include, for example, measurements of Received Signal Strength Indicator (RSSI), a Reference Signal Received Quality (RSRQ) value, a signal-to-interference-plus-noise ratio (SINR), time of arrival (ToA) measurement, a TA value, frequency band information, a physical cell identifier (PCI), etc. Additionally, according to implementations described herein, RAN 120 may obtain a TA delta value for UE device 110. For example, as described in connection with FIGS. 4A-4C, a wireless access device 125 may detect variances in timing alignment of received uplink frames to obtain TA delta 440. The TA delta can be computed based on signals from a PUCCH, a PUSCH, or an SRS. In one implementation, the TA delta value may include a sampling rate corresponding to the bandwidth of the LTE/NR carrier and an integer value corresponding to the number of sampling intervals plus the remaining integer number of TA values which are not sent over-the-air (OTA). In another implementation, the TA delta value may include a whole number plus a fractional component of the sampling interval (although a fractional component of the sampling interval may be difficult in a discretized system). In still other implementations, RAN 120 may indicate a calculated distance based on the TA delta value and the TA integer value.

As an example, consider that a UE device 110 is 2 km, or 2000 meters, from gNB 210. The 2000 meters corresponds to 25*78.1 meters +47.5 meters. Assume that the value of 25 (which corresponds to a TA value of 200, as TA is in steps of 9.7625 meters) is already sent over the air (OTA) and UE device 110 has corrected for it. Now 47.5 meters will be left as the uncorrected value. The 47.5 meters corresponds to 4 TAs (4*9.7625 meters)+8.45 meters. The 8.45 meters is a fractional TA of 8.45/9.7625=0.865557. The 8.45 meters may also be presented as 55.3 sampling intervals (in units of Ts=0.508626 ηs). Hence, the additional TA delta (i.e., TA delta 440) can be (a) in terms of distance, 47.5 meters (or the equivalent number in time, like 311 Ts), or (b) 4 full TA+0.865557=4.865557 TA, or (c) 4 full TA+55 sampling intervals (Ts). Hence, when the distance is to be computed, location measurements 630 may include the OTA TA value (e.g., TA value 420, which is 200 in this example) plus the additional TA delta 440 (in any of the formats (a), (b), or (c) above).

RAN 120 may return the obtained location information (e.g., including the TA delta) to AMF 240 in a network positioning message (e.g., an NRPPa message) included in, for example, a transport message 640 (e.g., an N2 Transport message). In one implementation, RAN 120 may also include the routing identifier received in transport message 620. The TA delta may be sent in any of multiple formats. According to an implementation, a standardized network positioning message may be configured to accommodate a new information element or another field to include a TA delta in addition to other location-related information.

AMF 240 may receive transport message 640 and use a transport protocol to send a transport message 650 (e.g. a location transport response) to LMF 230 (e.g., the LMF associated with the routing identifier in message 640). Transport message 650 may include the network positioning message received in transport message 640 and a UE identifier for UE device 110. LMF 230 may initiate another transport message 610 to request further location information for UE device 110 and/or capabilities from RAN 120.

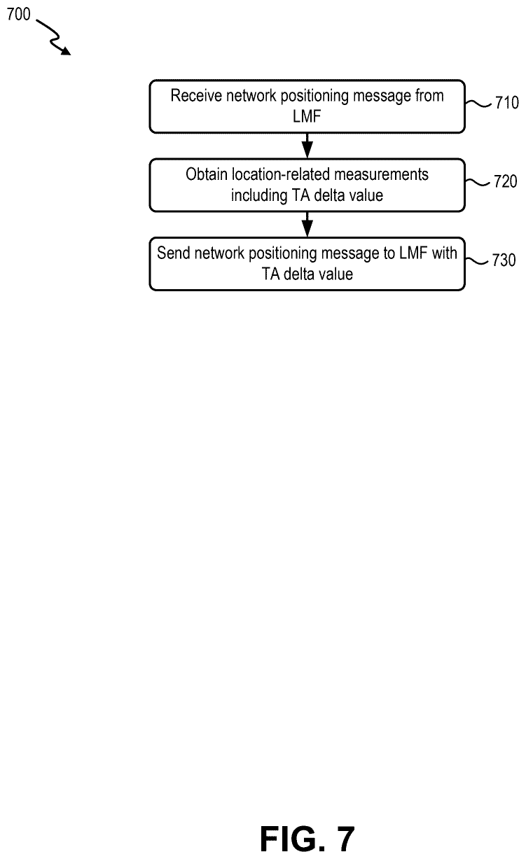

FIG. 7 is a flow diagram illustrating a process 700 for providing an improved location estimation service using timing advance (TA) corrections. According to an implementation, process 700 may be performed, for example, by wireless access stations 125 in RAN 120. In other implementations, process 600 may be performed by wireless access stations 125 in conjunction with AMF 240, LMF 230, or other devices or functions in network portion 200.

Process 700 may include receiving a network positioning message from an LMF (block 710). For example, LMF 230 may send a location request to AMF 240 requesting that a network positioning message (e.g. an NRPPa message) be sent to the serving wireless access station 125 for UE device 110 within the RAN 120. The location request may include the network positioning message and a UE identifier for UE device 110. AMF 240 may receive and forward the location request to the wireless access station 125 serving UE device 220 in RAN 120.

Process 700 may further include obtaining location-related measurements including a TA delta value (block 720). For example, wireless access station 125 may receive the location request and, in response, obtain location-related information for the designated UE device 110. The location-related information may include, among other data, a TA delta value for UE device 110.

Process 700 may also include sending a network positioning message with the location related measurements (block 730). For example, wireless access station 125 may return the obtained location information (e.g., including the TA delta) to AMF 240. The TA delta may be sent in any of multiple formats. In one implementation, wireless access station 125 may include a routing identifier for the requesting LMF 230. AMF 240 may receive the location information and send a location response to LMF 230 (e.g., the LMF associated with the routing identifier).

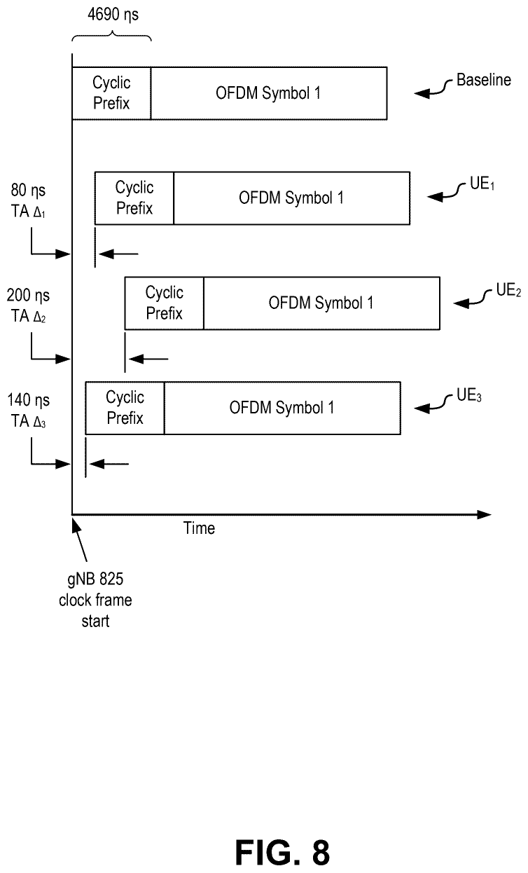

FIG. 8 is a diagram illustrating a use case for providing an improved location estimation service using TA corrections. More particularly, FIG. 8 illustrates an example of collecting location estimation data in a network portion 800 with multiple UE devices 110 (e.g., UE₁, UE₂, UE₃) connected to a gNB 825 (e.g., corresponding to one of wireless access devices 125) using 15 KHz SCS. Assume the cyclic prefix for network portion 800 is 4690 ηs and the timing advance is 260.4 ηs. A baseline or expected arrival time for uplink signals is known to gNB 825 based on the assigned timing advance for each UE device 110.

The gNB 825 may receive from each of UE₁, UE₂, and UE₃, OFDM symbols with the cyclic prefix (CP) of 4690 ηs. Based on the expected arrival time, UE₁ may have a TA delta (Δ₁) of 80 ηs, which may translate to about 24 meters. UE₂ may have a TA delta (Δ₂) of 200 ηs, which may translate to about 60 meters. UE₃ may have a TA delta (Δ₃) of 140 ηs, which may translate to 42 meters. Each Δi will not be compensated by the timing advance from the respective UE, since the relatively larger value of the cyclic prefix will enable gNB 825 to align the OFDM symbols. However, the gNB 825 will be able to detect and collect the respective Δᵢ value associated with each UE.

Upon request from LMF 230, for example, gNB 825 may provide the timing advance value (i.e., 260.4 ηs or multiples of 260.4 ηs) and TA delta value for each of UE₁, UE₂, and UE₃. In one implementation, the TA delta may be provided in a standardized format supported by an N2 or NG-C interface between RAN 120 and AMF 240 and supported by the NLs interface between AMF 240 and LMF 230. In another implementation, the TA delta may be included within the NRPPa protocol. Based on the TA delta, LMF 230 may calculate more precise location information for each of UE₁, UE₂, and UE₃.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustrations but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of communications have been described with regard to FIG. 6 and series of blocks have been described with regard to the processes illustrated in FIG. 7, the order of the communications and blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 330. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, it should be understood that such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a radio access network (RAN) device, a request for location information;
obtaining, by the RAN device, location measurements for a User Equipment (UE) device, wherein the location measurements include a timing advance delta for a received uplink radio frame; and
sending, by the RAN device, a response to the request, wherein the response includes the timing advance delta.

2. The method of claim 1, wherein receiving the request for location information includes receiving the request originating from a location management function (LMF) via an access and mobility management function (AMF).

3. The method of claim 1, wherein the request for location information includes a UE identifier for the UE device.

4. The method of claim 1, wherein the request for location information includes a routing identifier for a location management function (LMF) that originated the request.

5. The method of claim 1, wherein the timing advance delta includes a sampling rate for a carrier bandwidth used by the UE device and an integer value corresponding to a number of sampling intervals.

6. The method of claim 1, wherein the timing advance delta is computed using information from a Physical Uplink Control Channel (PUCCH), a Physical Uplink Shared Channel (PUSCH), or a Sounding Reference Signal (SRS).

7. The method of claim 1, wherein sending the response to the request includes:
sending the response to a location management function (LMF), via an access and mobility management function (AMF).

8. The method of claim 7, wherein sending the response to the request includes:
sending the response to a location management function (LMF) via a standardized network positioning message.

9. The method of claim 7, further comprising:
applying, by the LMF, the timing advance delta to improve a distance determination for the UE device.

10. A device comprising:
one or more processors configured to:
receive a request for location information;
obtain location measurements for a User Equipment (UE) device, wherein the location measurements include a timing advance delta for a received uplink radio frame; and
send a response to the request, wherein the response includes the timing advance delta.

11. The device of claim 10, wherein the request originates from a location management function (LMF), and, when receiving the request for location information, the one or more processors are further configured to:
receive the request originating from an access and mobility management function (AMF) in a core network.

12. The device of claim 10, wherein the request for location information includes:
a UE identifier for the UE device, and
a routing identifier for the LMF.

13. The device of claim 10, wherein the timing advance delta includes a sampling rate for a carrier bandwidth used by the UE device and an integer value corresponding to a number of sampling intervals.

14. The device of claim 10, wherein the timing advance delta is computed using information from a Physical Uplink Control Channel (PUCCH), a Physical Uplink Shared Channel (PUSCH), or a Sounding Reference Signal (SRS).

15. The device of claim 10, wherein, when sending the response, the one or more processors are further configured to:
send the response to a location management function (LMF), via an access and mobility management function (AMF).

16. The device of claim 10, wherein the device is a next generation Node B (gNB) or a next generation evolved Node B (ng-eNB).

17. The device of claim 10, wherein, when sending the response, the one or more processors are further configured to:
send the response to a location management function (LMF) via a standardized network positioning message.

18. A non-transitory, computer-readable storage medium storing instructions, executable by a processor of a network device, for:
receiving, by the radio access network (RAN) device, a request for location information;
obtaining, by the RAN device, location measurements for a User Equipment (UE) device, wherein the location measurements include a timing advance delta for a received uplink radio frame; and
sending, by the RAN device, a response to the request, wherein the response includes the timing advance delta.

19. The non-transitory, computer-readable storage medium of claim 18, wherein the timing advance delta includes a sampling rate for a carrier bandwidth used by the UE device and an integer value corresponding to a number of sampling intervals.

20. The non-transitory, computer-readable storage medium of claim 18, wherein the instructions for sending the response are further for:
sending the response to a location management function (LMF), via an access and mobility management function (AMF).
